(19) United States
(12) Patent Application Publication
(10) Pub. No.: US 2004/0099100 A1
(43) Pub. Date: May 27, 2004

(54) Wrench head

(76) Inventor: Bobby Hu, Taichung (TW)

Correspondence Address: Alan D. Kamrath, Rider Bennett, LLP, Suite 2000, 333 South Seventh Street, Minneapolis, MN, 55402, US

(21) Appl. No.: 10/714,350

(22) Filed: Nov. 14, 2003

(30) Foreign Application Priority Data
Mar. 12, 2002 (TW) 91219696

(51) Int. Cl. B25B 13/02

(52) U.S. Cl. 81/119

(57) ABSTRACT

A wrench head includes a first end having a drive portion for driving a fastener. A second end of the wrench head includes a star polygonal hole that is a treble square hole having twelve angled portions. Each angled portion includes two sidewalls meeting at a common line. The respective sidewall of the respective angled portion joins an associated sidewall of another angled portion adjacent to the respective angled portion, forming a ridge.

### BACKGROUND OF THE INVENTION

1. Field of the Invention

The present invention relates to a wrench head. In particular, the present invention relates to a wrench head suitable for use in a limited space.

2. Description of the Related Art

U.S. Pat. No. 5,582,083 discloses an open end wrench with a removable handle. The wrench head of the open end wrench includes an upper jaw and a lower jaw that are connected by a web. A polygonal drive hole extends through a square neck of the wrench head and includes four sidewalls each having a cavity for retaining a ball of a drive post of the handle. Since the drive hole is polygonal, the handle can have four engaging positions relative to the wrench head. Nevertheless, use of the wrench in a limited space is inconvenient or even difficult, as the respective engaging positions are spaced by 90 degrees.

U.S. Pat. No. 4,774,862 discloses an open-ended wrench which, as illustrated in FIG. 1 of the drawings, is designated by 50 and includes an arch-shaped jaw 52 and a double square socket 64, providing eight engaging positions for a square tang 126 of a handle 124. Thus, the respective engaging positions are spaced by 45 degrees. However, as illustrated in FIG. 2, use of this wrench in a limited space is still unsatisfactory, as the handle 124 is apt to be hindered by obstacles and thus could not move downward to engage with the double square socket 64. Further, the sidewalls of the double square socket 64 have no cavity and thus fail to provide a retaining effect for the ball 128 of the square tang 126. Namely, the ball 128 of the square tang 126 is received in an associated corner of the double square socket 64 without effective retaining effect. As a result, the handle 124 is apt to disengage from the wrench 50, causing problems in operation.

### SUMMARY OF THE INVENTION

In accordance with an aspect of the present invention, a wrench head has a first end and a second end. The first end includes a drive portion for driving a fastener. The second end includes a star polygonal hole that is a treble square hole having twelve angled portions. Each angled portion includes two sidewalls meeting at a common line. The respective sidewall of the respective angled portion joins an associated sidewall of another angled portion adjacent to the respective angled portion, forming a ridge.

A handle can be engaged with the wrench head in any one of twelve engaging positions. When use in a limited space, the handle can be detached from the wrench head and reengaged with the wrench head in an appropriate position for driving a fastener. Thus, the fastener can be tightened/loosened within a relatively short time.

Each ridge has a recessed portion for receiving a ball of a square tang of the handle. This provides a reliable positioning effect for retaining the square tang in the star polygonal hole of the wrench head while driving the fastener.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a conventional wrench.

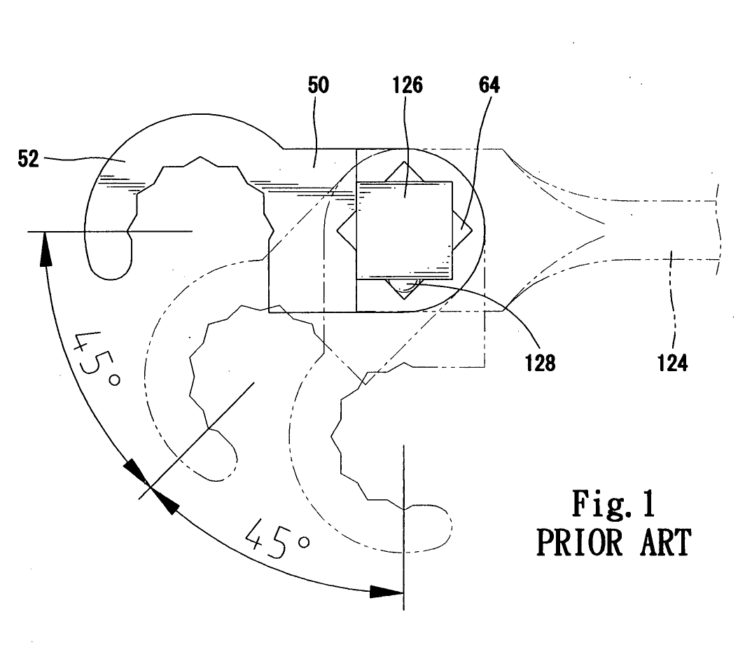

FIG. 2 is a schematic view illustrating use of the conventional wrench in a limited space.

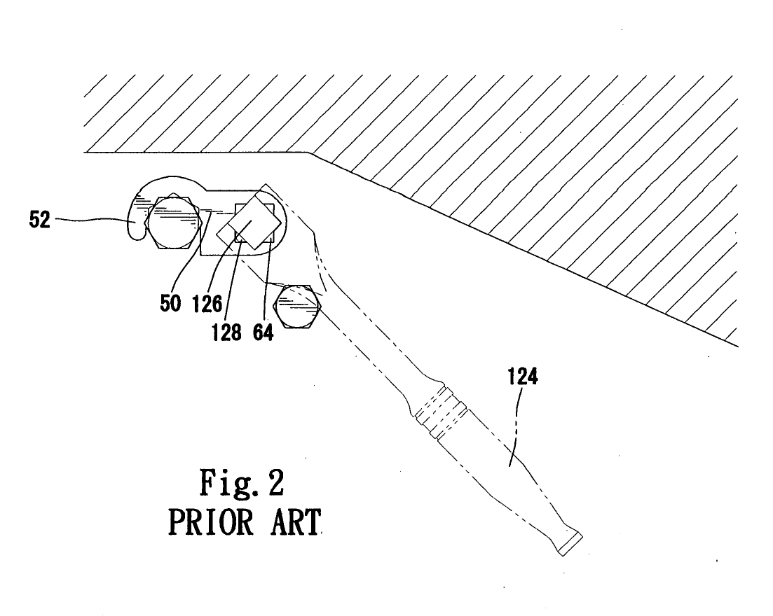

FIG. 3 is a perspective view of a wrench head in accordance with the present invention.

FIG. 4 is a top view of the wrench head in accordance with the present invention.

FIG. 5 is an exploded perspective view of a wrench including a handle and a wrench in accordance with the present invention.

FIG. 6 is a top view of the wrench in FIG. 5.

FIG. 7 is a schematic view illustrating use of the wrench in accordance with the present invention in a limited space.

FIG. 8 is a sectional view illustrating engagement between the wrench head and the handle.

FIG. 9 is a top view illustrating engagement between the wrench head and the handle.

FIG. 10 is a perspective view illustrating a modified embodiment of the wrench head in accordance with the present invention.

FIG. 11 is a perspective view illustrating another modified embodiment of the wrench head in accordance with the present invention.

FIG. 12 is a perspective view illustrating a further modified embodiment of the wrench head in accordance with the present invention.

FIG. 13 is a side view of the wrench head in FIG. 12, wherein a socket and a handle are coupled to the wrench head.

FIG. 14 is a perspective view illustrating still another modified embodiment of the wrench head in accordance with the present invention.

### DETAILED DESCRIPTION OF THE PREFERRED EMBODIMENTS

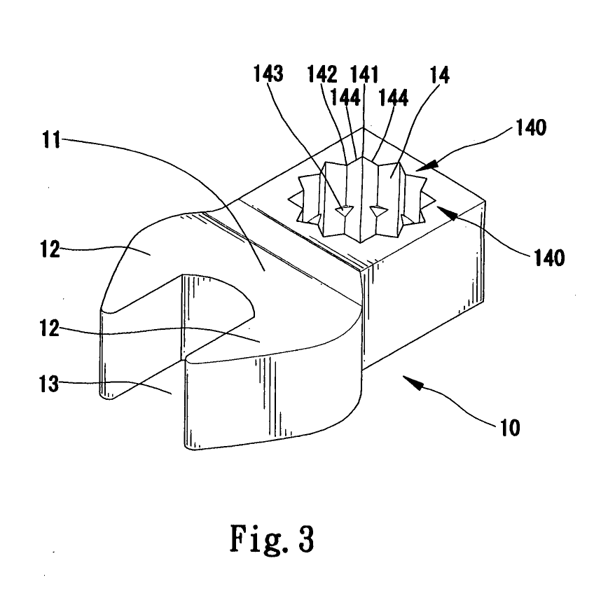

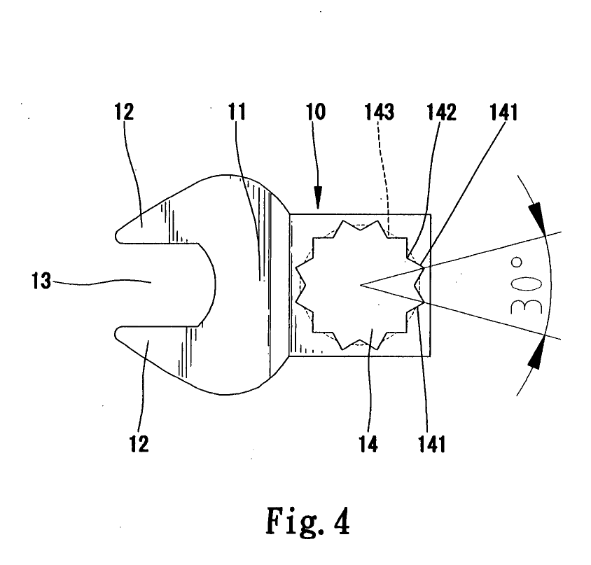

Referring to FIGS. 3 and 4, a wrench head 10 in accordance with the present invention generally comprises a first end and a second end. A drive portion 11 is formed on the first end of the wrench head 10 and includes two jaws 12 between which a space or opening 13 for receiving a fastener is defined. A star polygonal hole 14 is defined in the second end of the wrench head 10. In this embodiment, the star polygonal hole 14 is a treble square hole having twelve (12) angled portions 140 each having two sidewalls 144 and a common line (“apex line”) 141 where the sidewalls 144 meet. Each sidewall 144 of the respective angled portion 140 joins an associated one of the sidewalls 144 of another angled portion 140 adjacent to the respective angled portion 140, forming a ridge 142. The respective ridge 142 includes a recessed portion 143. As illustrated in FIG. 4, two of the apex lines 141 adjacent to each other are spaced apart by 30 degrees.

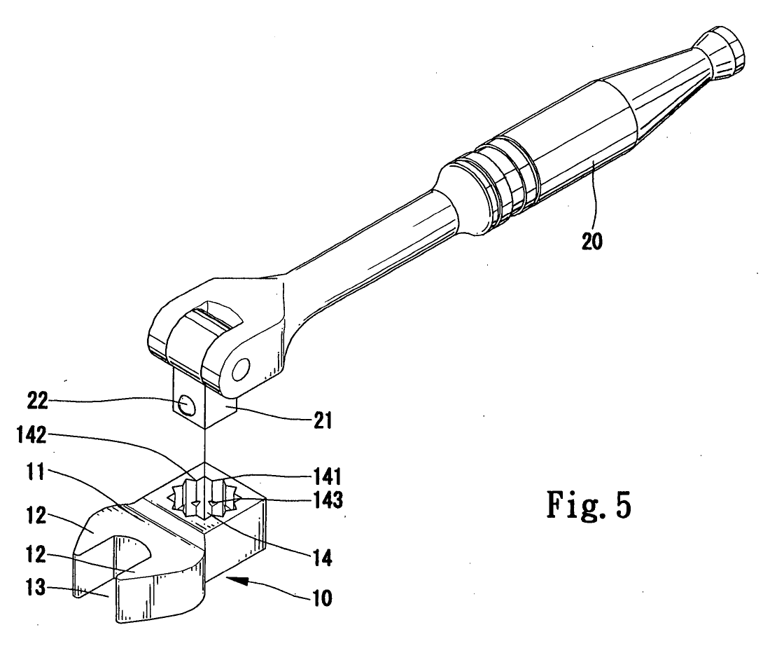

As illustrated in FIG. 5, the star polygonal hole 14 allows insertion of a square tang 21 on an end of a handle 20. The square tang 21 may be pivotable relative to the handle 20.

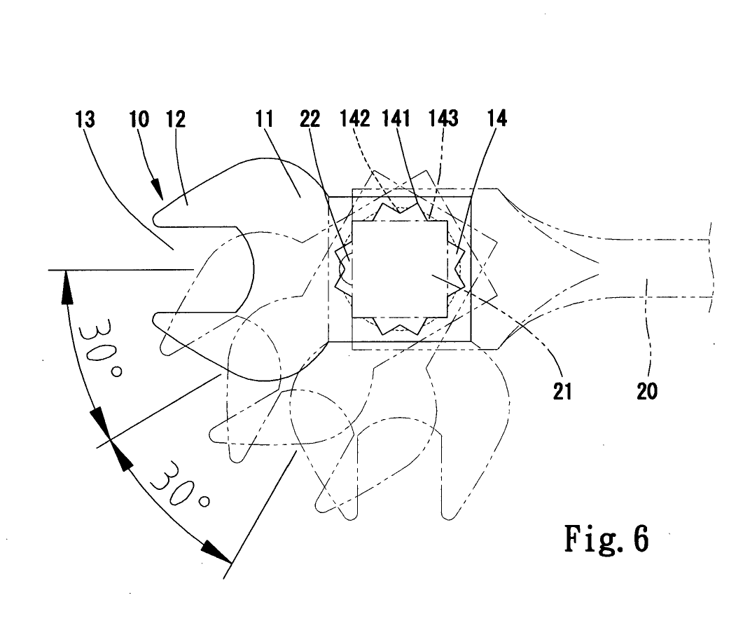

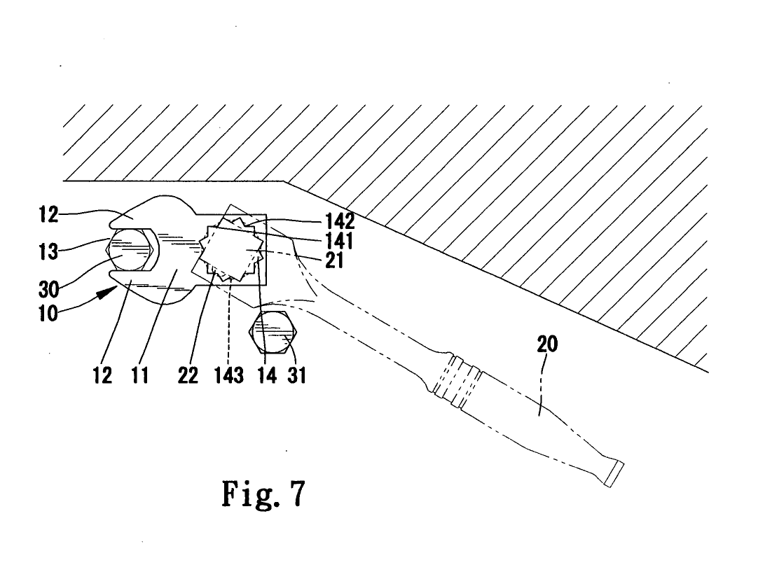

As illustrated in FIG. 6, since the star polygonal hole 14 is a treble square hole having twelve apex lines that are spaced apart from one another by 30 degrees. This allows the square tang 21 of the handle 20 to engage with the star polygonal hole 14 in any one of twelve different engaging positions that are spaced apart from one another by 30 degrees. Thus, the handle 20 and the wrench head 10 can be used in a limited space. As illustrated in FIG. 7, when in a limited space (e.g., the space below an engine hood), rotation of the handle 20 is apt to be hindered by many obstacles 31 while driving a fastener 30. Nevertheless, since the handle 20 can be engaged with the wrench head 10 in any one of twelve engaging positions, the handle 20 can be detached from the wrench head 10 and reengaged with the wrench head 10 in an appropriate position for driving the fastener 30. Thus, the fastener 30 can be tightened/loosened within a relatively short time.

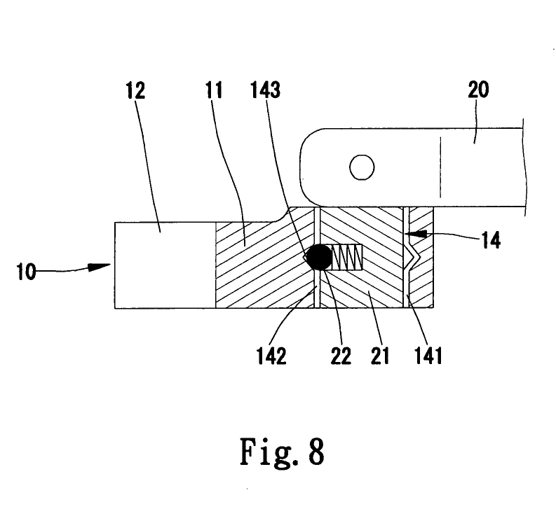

It is noted that the square tang 21 of the handle 20 can be securely engaged in the star polygonal hole 14 of the wrench head 10. As illustrated in FIG. 8, the ball 22 of the square tang 21 is biased by an elastic element (not labeled) in the square tang 21 to be engaged in the recessed portion 143 of an associated one of the ridges 142, providing a reliable positioning for the square tang 21 and the star polygonal hole 14 in a direction along which the respective ridge 142 extends. In particular, the ball 22 of the square tang 21 is securely engaged in the recessed portion 143 of the associated ridge 142 regardless of the engaging position of the handle 20.

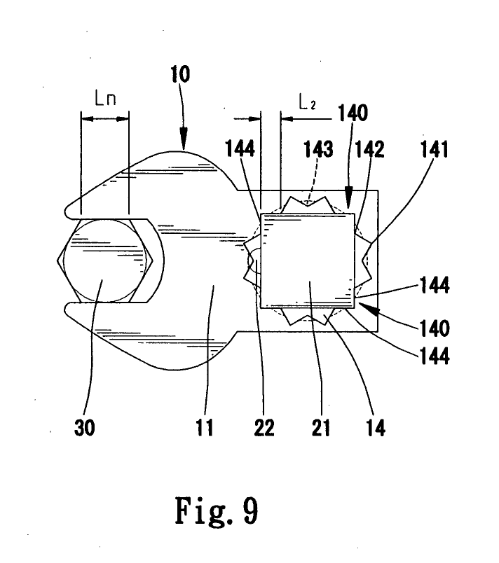

Referring to FIG. 9, the square tang 21 is engaged with four angled portions 140 of the star polygonal hole 14. The contact area between the square tang 21 and the angled portions 141 are 8×L2, where L2 is the width of the sidewall 144, whereas the contact area between the fastener 30 and the drive portion 11 of the wrench head 10 is 2×Ln, where Ln is the length of each side of the fastener 30. Since 8L2>2Ln, the respective corner 141 of the star polygonal hole 14 would not be damaged by the square tang 21 while driving the fastener 30. Thus, the force from the handle 20 can be effectively transmitted to the fastener 30.

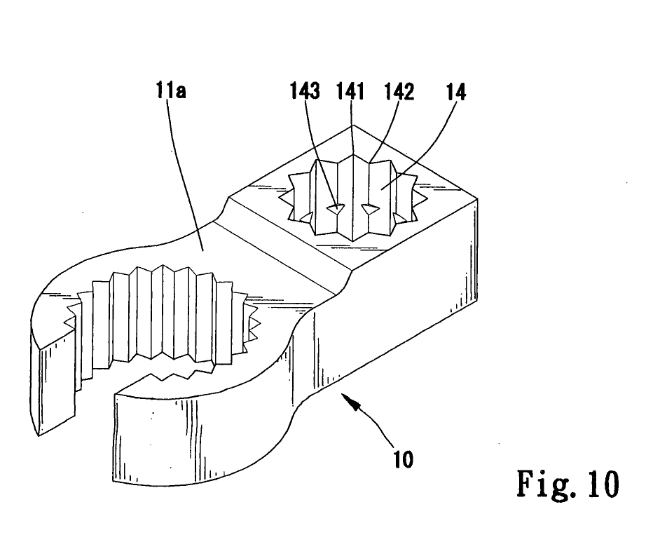

FIG. 10 illustrates a modified embodiment of the wrench head in accordance with the present invention, wherein the drive portion (now designated by 11a) of the wrench head 10 includes a substantially C-shaped box end.

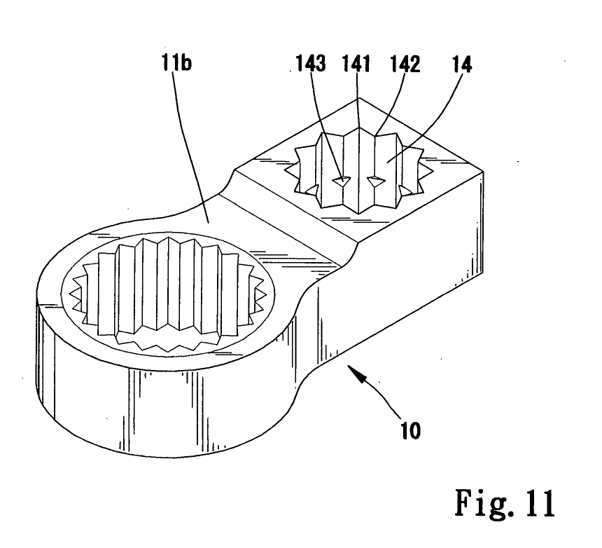

FIG. 11 illustrates another modified embodiment of the wrench head in accordance with the present invention, wherein the drive portion (now designated by 11b) of the wrench head 10 includes a box end.

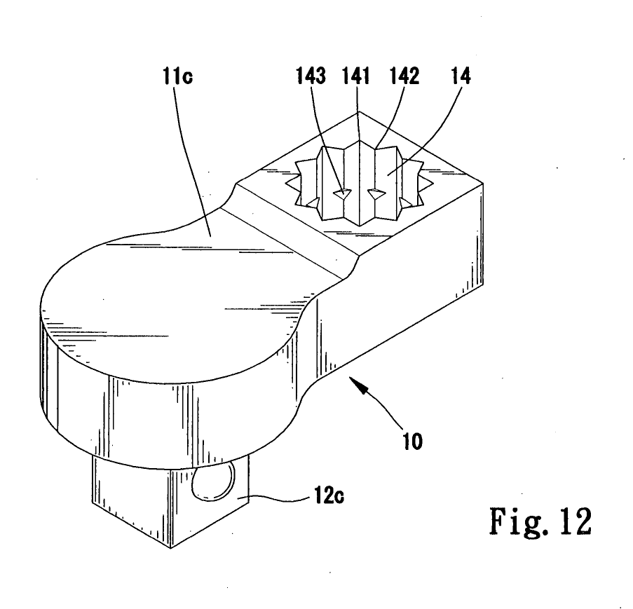

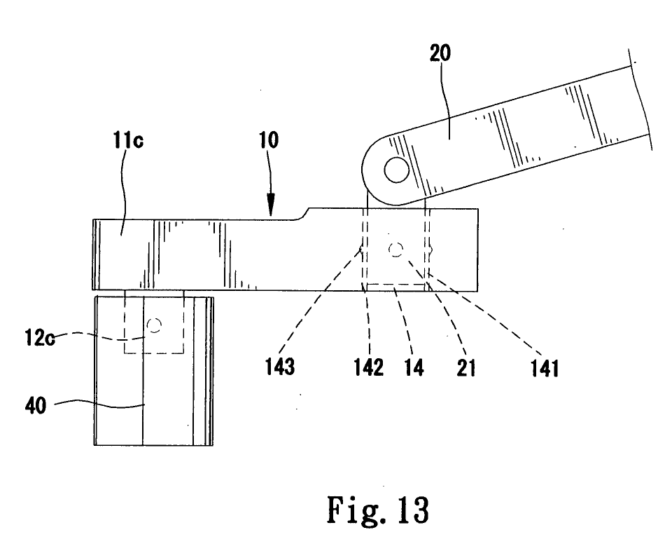

FIG. 12 illustrates a further modified embodiment of the wrench head in accordance with the present invention, wherein the drive portion (now designated by 11c) of the wrench head 10 includes a square tang 12c for driving a socket 40, as illustrated in FIG. 13. Further, a square tang 21 of a handle 20 is coupled to the star polygonal hole 14 of the wrench head 10.

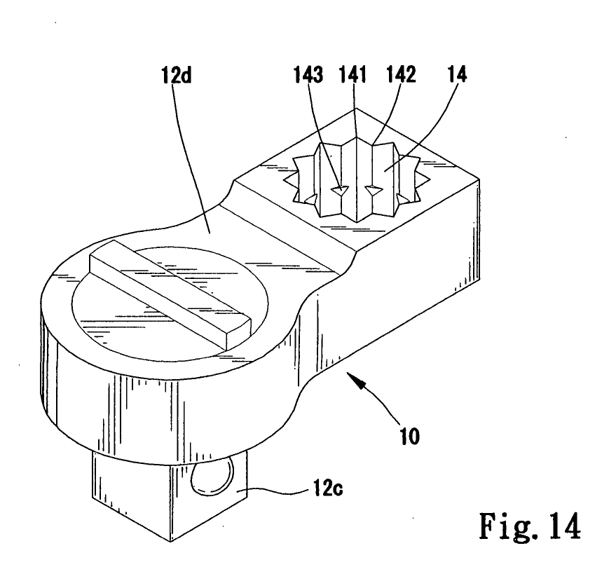

FIG. 14 illustrates still another modified embodiment of the wrench head in accordance with the present invention, wherein the drive portion of the wrench head 10 includes a square tang 12c for driving a socket 40, and wherein the wrench head 10 includes a reversible mechanism 12d, allowing reversible operation of the handle 20.

Although the invention has been explained in relation to its preferred embodiment, it is to be understood that many other possible modifications and variations can be made without departing from the scope of the invention as hereinafter claimed.

What is claimed is:

1. A wrench head comprising a first end and a second end, the first end including a drive portion for driving a fastener, the second end including a star polygonal hole that is a treble square hole having twelve angled portions, each said angled portion including two sidewalls meeting at a common line, the respective sidewall of the respective angled portion joining an associated one of the sidewalls of another angled portion adjacent to the respective angled portion, forming a ridge.

2. The wrench head as claimed in claim 1, wherein the common lines of the angled portions are spaced apart from one another by 30 degrees.

3. The wrench head as claimed in claim 1, wherein each said ridge includes a recessed portion adapt to receive a ball of a square tang of a handle that is engaged in the star polygonal hole.

4. The wrench head as claimed in claim 1, wherein the drive portion includes two jaws having an opening therebetween for receiving the fastener.

5. The wrench head as claimed in claim 1, wherein the drive portion includes a C-shaped box end.

6. The wrench head as claimed in claim 1, wherein the drive portion includes a box end.

7. The wrench head as claimed in claim 1, wherein the drive portion includes a square tang.

8. The wrench head as claimed in claim 7, wherein the drive portion includes a reversible mechanism.

9. The wrench head as claimed in claim 3, wherein a contact area between the angled portions of the wrench head and the square tang of the handle is greater than that between the drive portion and the fastener engaged with the drive portion.

10. The wrench head as claimed in claim 2, wherein each said ridge includes a recessed portion adapt to receive a ball of a square tang of a handle that is engaged in the star polygonal hole.

11. The wrench head as claimed in claim 2, wherein the drive portion includes two jaws having an opening therebetween for receiving a fastener.

12. The wrench head as claimed in claim 2, wherein the drive portion includes a C-shaped box end.

13. The wrench head as claimed in claim 2, wherein the drive portion includes a box end.

14. The wrench head as claimed in claim 2, wherein the drive portion includes a square tang.

15. The wrench head as claimed in claim 14, wherein the drive portion includes a reversible mechanism.

16. The wrench head as claimed in claim 10, wherein a contact area between the angled portions of the wrench head and the square tang of the handle is greater than that between the drive portion and the fastener engaged with the drive portion.

17. The wrench head as claimed in claim 3, wherein the drive portion includes two jaws having an opening therebetween for receiving a fastener.

18. The wrench head as claimed in claim 3, wherein the drive portion includes a C-shaped box end.

19. The wrench head as claimed in claim 3, wherein the drive portion includes a box end.

20. The wrench head as claimed in claim 3, wherein the drive portion includes a square tang.
